(19) United States
(12) Patent Application Publication
(10) Pub. No.: US 2025/0022158 A1
(43) Pub. Date: Jan. 16, 2025

(54) OPTIMIZED METHOD FOR IDENTIFICATING ROBOT POURING REGIONS BASED ON HIERARCHICAL PROCESSING AND CONNECTIVITY MAXIMIZATION AND SYSTEM THEREOF

(71) Applicant: SHANDONG UNIVERSITY, Jinan (CN)

(72) Inventors: Rui SONG, Jinan (CN); Xincheng TIAN, Jinan (CN); Xuewen RONG, Jinan (CN); Xin MA, Jinan (CN); Lelai ZHOU, Jinan (CN); Chaoqun WANG, Jinan (CN); Yixiang LIU, Jinan (CN); Huanghe ZHANG, Jinan (CN)

(73) Assignee: SHANDONG UNIVERSITY, Jinan (CN)

(21) Appl. No.: 18/746,492

(22) Filed: Jun. 18, 2024

(30) Foreign Application Priority Data
Jul. 12, 2023 (CN) 2023108548085

(51) Int. Cl. G06T 7/70; G05D 1/646; G05D 101/15; G05D 111/10; G06T 5/70; G06T 7/50

(52) U.S. Cl. CPC G06T 7/70; G05D 1/646; G06T 5/70; G06T 7/50; G05D 2101/15; G05D 2111/10

(57) ABSTRACT

An optimized method for identifying robot pouring regions based on hierarchical processing and connectivity maximization and a system thereof, wherein the optimized method includes: rough identification stage: identifying and positioning, according to working characteristics of mobile robot, target container through vision module when a distance from target region is relatively far, and generating information collection position of target container required for fine identification according to the positioning; fine identification stage: obtaining, by mobile robot, information of target container and source container, and generating corresponding connectable domains, then identifying and optimizing robot pouring region by using connectivity maximization method. It solves problems of autonomous identification of pouring region of the mobile robot, can be applied to most target containers and source containers, and enhances the generalization ability of robot pouring manipulation skills.

### TECHNICAL FIELD

The present invention belongs to the technical field of identification of robot pouring, and it particularly relates to an optimized method for identifying robot pouring regions based on hierarchical processing and connectivity maximization and a system thereof.

### BACKGROUND

The statements in this section merely provide background information related to the present invention and are not necessarily prior art.

The pouring skill of robots is a very widely used manipulation skill, whether it is home service or laboratory manipulation, there are many direct application scenarios. Because of the diversity of manipulating objects (e.g. liquid, particle, or powder) of the pouring manipulation, complex dynamic processes have been incorporated into the manipulating tasks of the pouring manipulation, which brings great challenge to robot manipulation skill learning. How to learn accurate and widely applicable pouring manipulation skills has become an important topic in the field of robot manipulation skills learning.

The existing research on robot pouring manipulation skill learning mainly focuses on the control and learning of the pouring action of fixed-type mechanical arms, which is often given a fixed pouring region for the robot, but it is difficult to realize the autonomous selection and optimization of the pouring region for the robot, which makes it difficult for the robot to complete the whole process of pouring task autonomously.

### SUMMARY

In order to solve at least one technical problem mentioned in the background above, the present invention provides an optimized method for identifying robot pouring regions based on hierarchical processing and connectivity maximization and a system thereof, which can realize the identification and the optimization of the identification of the pouring region of a mobile robot, can be widely adapted to different pouring scenarios, and can be easily extended to the process of learning the pouring manipulation skill of a fixed-type mechanical arm, thereby providing support for the learning and realization of accurate and applicable extensive pouring manipulation skills of the robot.

In order to achieve the above object, the present invention adopts the following technical solutions.

A first aspect of the present invention provides an optimized method for identifying robot pouring regions based on hierarchical processing and connectivity maximization, comprising the following steps:
performing a preliminary location of a target container based on environmental information image to obtain a spatial region of the target container;
generating a trajectory plan and a path plan of a mobile chassis of a mobile robot according to the spatial region of the target container; and, performing a fine identification by controlling a mechanical arm of the mobile robot to move to an information collection position according to the trajectory plan and the path plan, to obtain a pouring region; wherein, a process of the fine identification specifically comprises:
acquiring image information of the target container and a source container;
generating corresponding connectable domain based on the image information of the target container and the source container; and
searching, by using a method of connectivity maximization, a pouring point of the source container which makes an intersection of the connectable domains of the source container and the target container maximum in a searching plane, and a pouring direction, further obtaining positions of pouring points on the source container, and then obtaining the pouring region according to a combination of the positions of the pouring points.

A second aspect of the present invention provides an optimized system for identifying robot pouring regions based on hierarchical processing and connectivity maximization, comprising:
a rough-identification module, being configured to perform a preliminary location of a target container based on an environmental information image to obtain a spatial region of the target container; and being configured to generate a trajectory plan and a path plan of a mobile chassis of a mobile robot according to the spatial region of the target container; and
a fine-identification module, being configured to perform a fine identification by controlling a mechanical arm of the mobile robot to move to an information collection position according to the trajectory plan and the path plan, to obtain a pouring region; wherein, a process of the fine identification specifically comprises:
acquiring image information of the target container and a source container;
generating corresponding connectable domain based on the image information of the target container and the source container; and
searching, by using a method of connectivity maximization, a pouring point of the source container which makes an intersection of the connectable domains of the source container and the target container maximum in a searching plane, and a pouring direction, further obtaining positions of pouring points on the source container, and then obtaining the pouring region according to a combination of the positions of the pouring points.

A third aspect of the invention provides a non-transitory computer-readable storage medium.

The non-transitory computer-readable storage medium having a computer program stored thereon, when the computer program is executed by a processor, implementing steps of the optimized method for identifying robot pouring regions based on hierarchical processing and connectivity maximization according to the first aspect.

A fourth aspect of the invention provides computer equipment.

The computer equipment, comprising a memory, a processor, and a computer program stored on the memory and executable on the processor, when the processor executing the program, implementing steps of the optimized method for identifying robot pouring regions based on hierarchical processing and connectivity maximization according to the first aspect.

Compared with the prior art, the present invention has the advantages that:
1. According to the present invention, proposing the method to determine the optimal pouring region of the robot by using the connectivity maximization, and proposing a corresponding simplified calculation for the method, to solve the problem of the autonomous identification of the pouring region of the mobile robot.
2. According to the present invention, the proposed method has strong generalization function, can be applied to most target containers and source containers, and enhances the generalization ability of the robot pouring manipulation skill.
3. According to the present invention, proposing a framework of the pouring region identification based on hierarchical processing and connectivity maximization for mobile robot pouring region identification, which can be applied to mobile robot pouring regions or migrated to fixed-type mechanical arms, having a wide range of applications.

Additional aspects of the present invention will be set forth in part in the description which follows, and in part will be obvious from the description, or may be learned by practice of the present invention.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 shows a system of a mobile work robot system provide by embodiments of the present invention and a pouring scenario;

FIG. 2 is a flowchart of an optimized method for identifying robot pouring regions based on hierarchical processing and connectivity maximization provided by embodiments of the present invention;

FIG. 3 is a schematic diagram of a model of connectible components of a target container provided by embodiments of the present invention;

FIG. 4 is a schematic diagram of a model of connectible components of a source container provided by embodiments of the present invention;

FIG. 5 is a schematic diagram of a projection plane, rectangular division, and weight distribution of the connectible components of the source container provided by embodiments of the present invention;

FIG. 6 is a schematic diagram of the projection plane of the connectible components of the source container including an opening trajectory provided by embodiments of the present invention;

FIG. 7 is an execution schematic diagram of a simplified search process provided by embodiments of the present invention.

### DETAILED DESCRIPTION

The present invention will now be further described with reference to the accompanying drawings and examples.

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is also intended to include the plural form unless the context clearly dictates otherwise. In addition, it should further be understood that, the terms “comprise” and/or “include” used in this specification indicate that there are features, steps, operations, devices, components, and/or combinations thereof.

In order to enable a mobile robot to master an optimized skill of autonomous identification of a pouring region and realize autonomous completion of a complete pouring task flow, the present invention provides an optimized method for identifying robot pouring regions based on hierarchical processing and connectivity maximization, to realize the autonomous identification of the pouring region by the mobile robot and optimization of the identification.

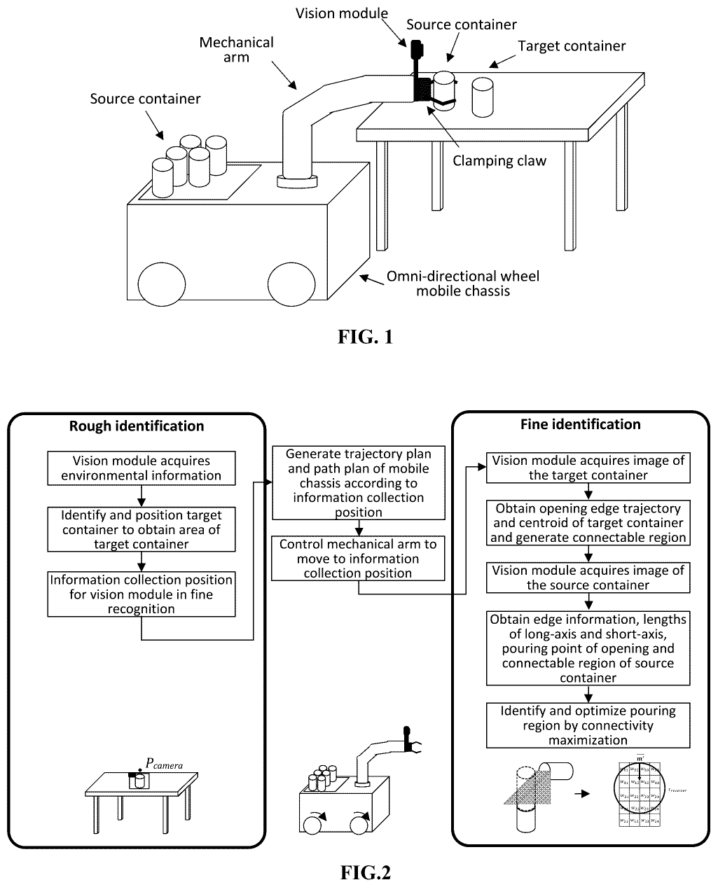

According to the proposed method of the present invention, a system for a mobile robot and a pouring task scenario as shown in FIG. 1 are built.

The system comprises a mobile-chassis module (this module comprises an omni-directional wheel motion-control subsystem, a radar-positioning subsystem and other subsystems, and is used for realizing a motion control and an obstacle avoidance function of the mobile robot), a mechanical-arm module (this module comprises a mechanical-arm sub-module and a clamping-claw module used for holding a container, and is used for realizing clamping of a source container and realization of camera actions and pouring actions), a vision module (this module comprises an RGB-D camera, a camera bracket and the like, and is used for identifying a source container, a target container and a working environment); further, the pouring task scenario comprises a source container (a container used for pouring substances, an initial state of the container is that the container contains substances to be poured, and an opening of the container is an axisymmetric figure), a target container (a container used for receiving the substances) and a matched working environment.

The goal of the robot pour manipulation skill is to be able to accurately pour substances from source containers into target containers with broad adaptability. The accurate pouring requires that the robot minimize a spillage of the substances throughout the pouring manipulation, while the broad adaptability requires that the robot be able to adapt to a variety of source containers, target containers, and pouring scenarios.

In order to realize the mobile robot to accurately complete the pouring manipulation with broad adaptability, the present invention proposes the optimized method for identifying robot pouring regions based on hierarchical processing and connectivity maximization, of which a core point is to adopt a hierarchical processing for the optimization of the identification process of the pouring region according to the working characteristics of mobile robot, and further proposes the model of the connectable domain of the source container that can predict the fluid flow region in the source container, and ultimately achieve autonomous intelligent identification of the optimal pouring region by maximizing the connectivity.

### Embodiment 1

As shown in FIG. 2, the present embodiment provides an optimized method for identifying robot pouring regions based on hierarchical processing and connectivity maximization, comprising the following steps:

### First Stage: Rough Identification

The present stage of the rough identification is to perform, according to working characteristics of a mobile robot, an identification and a positioning of a target container through a vision module when a distance from a target region is relatively far, and generate information collection position of the target container required for a fine identification according to the positioning, comprising the following steps:
Step 1: acquiring environmental information (image I_{work}) by using the vision module;
Step 2: extracting information of the image I_{work} to identify and position the target container to obtain a spatial region of the target container Ω_{receiver}; and
Step 3: generating information collection position P_{camera} for the vision module in the fine identification stage according to the spatial region of the target container Ω_{receiver}.

Wherein, the step 2 includes the following steps:
performing the identification of the target container by using a YOLO (You Only Look Once) algorithm trained by container-class dataset, to obtain a region of the target container in the image and marking an identification frame; and
performing gray processing and binary processing on the image according to the identified position of the target container in the image, to obtain centroid coordinates (x_{c}, y_{c}) of the region of the target container, and further obtaining center coordinates (xᵤ, yᵤ) of an upper edge of the target container, and then calculating world coordinates (x_{w}, y_{w}, z_{w}) of the target container according to a target distance obtained by a depth camera.

Wherein, the step 3 includes the following steps:
obtaining the information collection position P_{camera}=((x_{w}, y_{w}, z_{w}+h_{camera})) for the vision module in the fine identification stage by increasing h_{camera} on the z-axis of the world coordinates of the target container; wherein, the value of h_{camera} is different according to the camera model and resolution, and setting a distance for obtaining the best photographing effect.

Wherein, h_{camera} refers to the distance that the camera needs to keep from the object to be photographed when taking pictures to obtain information, and this distance needs to integrate a reachable range of the mechanical arm and the camera shooting parameters. For example, a distance test range of a RealSense camera is 0.1-10 m, so it is best for the camera to keep the distance from the object to be photographed at a distance of more than 0.1 m, cannot be tightly attached.

After obtaining the information collection position P_{camera} in the rough identification stage, planning a motion trajectory of the mobile chassis by using the RRT (rapidly-exploring random tree) algorithm, and controlling the mobile chassis to move to a vicinity of a target position according to the motion trajectory, and then generating, by using the inverse kinematics method, joint parameters of the mechanical arm according to the information collection position P_{camera} generated in the rough identification stage, and moving the vision module of the mechanical arm to the information collection position.

### Second Stage: Fine Identification

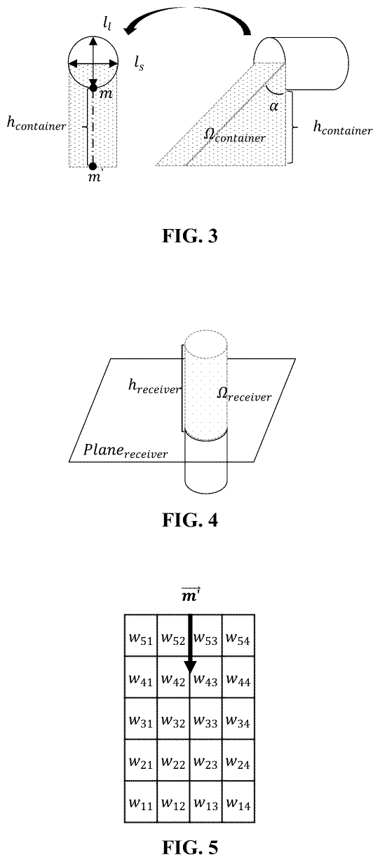

In the present stage of the fine identification, firstly obtaining, by the mobile robot, the information of the target container and the source container and generating corresponding connectable domain, and then identify and optimize the robot pouring region by using the method of connectivity maximization.

Wherein, a specific process is as follows:
Step 1: obtaining image information (image I_{receiver}) of the target container through the vision module;
Step 2: extracting information of the image I_{receiver}, obtaining an edge trajectory τ_{receiver} and a centroid O_{receiver} of an opening of the target container, and generating a connectable domain Ω_{receiver} of the source container according to a connectable domain model;
Step 3: obtaining image information (image I_{container}) of the source container through the vision module;
Step 4: extracting information of the image I_{container}, obtaining edge information τ_{container} of an opening of the source container, a long-axis length lₗ, and a short-axis length lₛ of the opening, and a pouring point m of the opening, and then generating a connectable domain Ω_{container} of the source container according to the connectable domain model; and
Step 5: identifying and optimizing the robot pouring region by using the method of connectivity maximization, and obtaining the pouring region according to a combination of positions of pouring point Ωₚₒᵤᵣ.

Wherein, the step 2 includes the following steps:
(1) performing noise reduction processing, gray processing, and binary processing on the image I_{receiver} respectively, and obtaining the edge trajectory τ_{receiver} and the centroid O_{receiver} of the opening of the target container by using a contour detection method and a characteristic moment in OpenCV; and
(2) according to the edge trajectory τreceiver of the opening of the target container, generating the region Ω_{receiver} as the connectable domain of the target container by making the area surrounded by the trajectory as a bottom and the parameter h_{receiver} as the high, as shown in FIG. 3.

Wherein, h_{receiver} can be defined as infinity or according to the following formula:

$${h}_{r e c e i v e r} = {l}_{l} / 2 + {h}_{c o n t a i n e r} ;$$

wherein, h_{container} is a parameter of the model of the connectable domain of the source container; h_{receiver} is upward projection length of a plane of the opening of the target container.

Wherein, the step 4 includes the following steps:
(1) performing noise reduction processing gray processing and binary processing on the image I_{container} respectively, and obtaining the edge trajectory τ_{container} and the centroid O_{container} of the opening of the source container by using the contour detection method and the characteristic moment method in the OpenCV, and then calculating the long-axis length lₗ and the short-axis length lₛ of the contour of the opening according to a circumscribed rectangle of the contour; calculating a vertical intersection of the centroid on the short axis of the circumscribed rectangle of the contour as a pouring point m of the source container.
(2) in this step, the connectable domain of the source container is generated, wherein: simplifying a region where the liquid flows out of the source container into a triangular prism having a base area of a right triangle with an angle of a and a height of lₗ/2+h_{hcontainer}, and a height lₛ according to the calculated long-axis distance lₗ and short-axis distance Iₛ of the contour of the opening, wherein the angle α can be set to different values according to the state of the fluid and the pouring angular velocity of the source container, the higher the viscosity of the liquid, the smaller the α value, the larger the pouring angular velocity of the source container, and the larger the α value, when the fluid property is unknown, α can be tentatively set to 45°, h_{container} is the distance from the pouring point m of the source container to a surface of the opening of the target container, which is an adjustable parameter greater than or equal to 0, wherein h_{container} can be set as 1 cm, that is, the pouring point of the source container is 1 cm away from the upper surface of the target container. In addition, a projection of the pouring point m on the surface of the opening of the target container is set as m′, and a unit vector [symbol] is formed by extending the opening direction of the container from the starting point m′. The connectable domain of the source container Ω_{container} constructed as described above is shown in FIG. 4.

The formula for the connectable domain of the source container is as follows:

$${Ω}_{c o n t a i n e r} = {l}_{s} \times {( {l}_{l} / 2 + {h}_{c o n t a i n e r} )}^{2} tan α$$

Advantages and rationality of using this method to set up the connectable domain are as follows:

When the fluid flows out from an opening, it is a complex calculation process to predict the trajectory and target region of the fluid using accurate fluid mechanics principles, and the generalization ability of the results of fluid mechanics calculation is poor due to the different properties of different fluids. However, the simplified model of the triangular prism with parameterized (α, lₗ, l, h) can well cover the flow region of the fluid, and has a wide range of applicability, which can facilitate the identification and optimization of the pouring region. In addition, FIG. 4 shows the case where the angle of the source container is 90° and the opening of the source container is circular. During actual pouring, the change in pouring angle can be accommodated by adjusting the model parameter α. The shape and size of the opening of the source container can also be generalized in the axisymmetric graph range, and the model can be widely adopted.

Wherein, the step 5 includes the following steps:

calculate a maximum value of the intersection region of the target container and the source container, expressed as follows:

$${max}_{m} {Ω}_{c o n t a i n e r ( m )} ⋂ {Ω}_{r e c e i v e r} s . t . \vec{{m}^{′}} ∈ {Plane}_{receiver}$$

The purpose of calculating the maximum value is to search for the position and direction of the maximum intersection [symbol] of the connectable domain of the source container and the target container in the Plane_{receiver}, and further obtain the position of the pouring point m on the source container.

Further optimization can be achieved by simplifying by using the following computational methods, specifically:
(1) projecting the connectable region Ω_{container} of the source container onto the Plane_{receiver}, and let the projected region be F, and a shape thereof be a rectangular;
(2) dividing the projection region F of the connectable domain of the source container into a×b rectangles equally, as shown in FIG. 5, and calculating the weight values wᵢⱼ of the rectangles according to the parameters of the connectable domain lₗ/2+h_{container};

the calculation formula of the weight is as follows:

$${w}_{i j} = i \times ( {l}_{l} / 2 + {h}_{c o n t a i n e r} ) / a ;$$

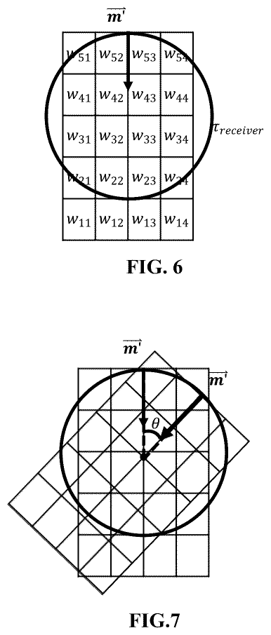

(3) searching for the sum of the weights of the projection plane of the connectable domain of the source container contained in the opening trajectory τ_{receiver} of the target container in the Plane_{receiver} (in practice, if the region contained in the weight rectangle exceeds ½, it is considered to be all contained), and the pouring point m corresponding to [symbol] corresponding to the maximum weight value is the pouring point and the pouring direction of the source container, as shown in FIG. 6.
(4) the search process can be further simplified according to the existing pouring knowledge, wherein taking the centroid O_{receiver} of the opening of the target container as the starting point, making a ray outward at an interval angle θ to intersect with the trajectory τ_{receiver} of the opening of the target container, and taking the intersection as the starting point, performing a searching by making the direction of [symbol] along the ray to the centroid, as shown in FIG. 7; and
(5) finally, the region composed of the pouring point m of the maximum sum of the weights contained in the trajectory τ_{receiver} of the opening of the target container is the pouring region Ωₚₒᵤᵣ identified and optimized by the method.

### Embodiment 2

The present embodiment provides an optimized system for identifying robot pouring regions based on hierarchical processing and connectivity maximization, comprising:

a rough-identification module, being configured to perform a preliminary location of a target container based on environmental information image to obtain a spatial region of the target container; and being configured to generate a trajectory plan and a path plan of a mobile chassis of a mobile robot according to the spatial region of the target container; and

a fine-identification module, being configured to perform a fine identification by controlling a mechanical arm of the mobile robot to move to an information collection position according to the trajectory plan and the path plan, to obtain a pouring region; wherein, a process of the fine identification specifically comprises:

acquiring image information of the target container and a source container;

generating corresponding connectable domain based on the image information of the target container and the source container; and

searching, by using a method of connectivity maximization, a pouring point of the source container which makes an intersection of the connectable domains of the source container and the target container maximum in a searching plane, and a pouring direction, further obtaining positions of pouring points on the source container, and then obtaining the pouring region according to a combination of the positions of the pouring points.

### Embodiment 3

The present embodiment provides a non-transitory computer-readable storage medium having a computer program stored thereon, when the computer program is executed by a processor, implementing steps of the optimized method for identifying robot pouring regions based on hierarchical processing and connectivity maximization as described in Embodiment 1.

### Embodiment 4

The present embodiment provides computer equipment, comprising a memory, a processor, and a computer program stored on the memory and executable on the processor, when the processor executing the program, implementing steps of the optimized method for identifying robot pouring regions based on hierarchical processing and connectivity maximization as described in Embodiment 1.

Those skilled in the art should understand that the examples of the present invention can be provided as methods, systems, or computer program products. Therefore, the present invention may take the form of hardware examples, software examples, or examples combining software and hardware aspects. Furthermore, the present invention may take the form of a computer program product implemented on one or more computer usable storage media (including but not limited to disk memory, optical memory, etc.) containing computer usable program codes.

The present invention is described with reference to flowcharts and/or block diagrams of methods, devices (systems), and computer program products according to the examples of the present invention. It should be understood that each of the processes and/or boxes in the flowchart and/or block diagram, and the combination of the processes and/or boxes in the flowchart and/or block diagram, may be implemented by computer program instructions. These computer program instructions may be provided to a processor of a general purpose computer, a specialized computer, an embedded processor, or other programmable data processing device to produce a machine such that the instructions executed by the processor of the computer or other programmable data processing device produce a device for implementing the functions specified in one process or multiple processes of the flowchart and/or one box or multiple boxes of the block diagram.

These computer program instructions may also be stored in a computer-readable memory capable of directing the computer or other programmable data processing apparatus to operate in a particular manner such that the instructions stored in such the computer-readable memory produce an article of manufacture comprising an instruction device that implements the function specified in one process or a plurality of processes of the flowchart and/or one box or a plurality of boxes of the block diagram.

These computer program instructions may also be loaded onto a computer or other programmable data processing device to enable a series of operational steps to be performed on the computer or other programmable device to generate a computer implemented process, so that instructions executed on a computer or other programmable device provide steps for implementing functions specified in one process or a plurality of processes of the flowchart and/or in one box or a plurality of boxes of the block diagram.

Those skilled in the art can understand that the realization of all or part of the processes in the methods of the above examples can be accomplished by instructing relevant hardware through a computer program. The program can be stored in a computer-readable storage medium. When the program is executed, it may comprise the processes of the examples of the above methods. The storage medium may be a disk, optical disc, Read-only memory (ROM), or random-access memory (RAM).

The foregoing descriptions are merely preferred embodiments of the present invention but are not intended to limit the present invention. A person skilled in art may make various alterations and variations to the present invention. Any modification, equivalent replacement, or improvement made within the spirit and principle of the present invention shall fall within the protection scope of the present invention.

1. An optimized method for identifying robot pouring regions based on hierarchical processing and connectivity maximization, comprising the following steps:
performing a preliminary location of a target container based on environmental information image to obtain a spatial region of the target container;
generating a trajectory plan and a path plan of a mobile chassis of a mobile robot according to the spatial region of the target container; and, performing a fine identification by controlling a mechanical arm of the mobile robot to move to an information collection position according to the trajectory plan and the path plan, to obtain a pouring region; wherein, a process of the fine identification specifically comprises:
acquiring image information of the target container and a source container;
generating corresponding connectable domain based on the image information of the target container and the source container; and
searching, by using a method of connectivity maximization, a pouring point and a pouring direction of the source container which make an intersection of the connectable domain of the source container and the target container maximum in a searching plane, further obtaining positions of the pouring point on the source container, and then obtaining the pouring region according to a combination of the positions of the pouring points.

2. The optimized method according to claim 1, wherein the performing the preliminary location of the target container based on the environmental information image to obtain the spatial region of the target container, comprising:
performing the identification of the target container by using a YOLO algorithm, obtaining a region of the target container in the environmental information image and marking an identification frame; and
performing gray processing and binary processing on the environmental information image according to a position of the identified region of the target container in the environmental information image, to obtain centroid coordinates of the region of the target container, and further obtaining center coordinates of an upper edge of the target container, and then calculating to obtain world coordinates of the target container combined with a target distance obtained by a depth camera.

3. The optimized method according to claim 1, wherein the generating the trajectory plan and the path plan of the mobile chassis of the mobile robot according to the spatial region of the target container, and controlling the mechanical arm of the mobile robot to move to the information collection position according to the trajectory plan and the path plan, comprising:
obtaining the information collection position for a stage of the fine identification by increasing a h_{camera} on the z-axis of the world coordinates of the target container; wherein, the h_{camera} refers to a distance that a camera needs to keep from an object to be photographed when taking pictures to obtain information; and
planning a motion trajectory of the mobile chassis by using a rapidly-exploring random tree (RRT) algorithm after obtaining the information collection position, controlling the mobile chassis to move to a vicinity of a target position according to the planned motion trajectory, then generating, by using an inverse kinematics method, joint parameters of the mechanical arm according to the information collection position generated in a stage of rough identification, and moving a vision module on the mechanical arm to the information collection position.

4. The optimized method according to claim 1, wherein the generating the connectable domain of the target container based on the image information of the target container, comprising:
performing noise reduction processing, gray processing, and binary processing on the image of the target container, obtaining an edge trajectory and a centroid of an opening of the target container by using a contour detection method and a characteristic moment method; and
using an area surrounded by the edge trajectory of the opening of the target container as a bottom and a parameter h_{receiver} as a high to generate a region as the connectable domain of the target container; wherein, the parameter h_{receiver} is an upward projection length of a plane of the opening of the target container.

5. The optimized method according to claim 1, wherein the generating the connectable domain of the source container based on the image information of the source container, comprising:
performing noise reduction processing, gray processing, and binary processing on the image of the source container, obtaining an edge trajectory and a centroid of an opening of the source container by using a contour detection method and a characteristic moment method, and calculating a long-axis length and a short-axis length of a contour of the opening according to a circumscribed rectangle of the contour, and then calculating a vertical intersection of the centroid on the short axis of the circumscribed rectangle of the contour as a pouring point of the source container;
simplifying a region where a liquid flows out of the source container into a triangular prism having a base area of a right triangle with an angle of α and a height of lₗ/2+h_{container}, and a height lₛ according to the calculated long-axis distance lₗ and short-axis distance lₛ; wherein, the angle α is set according to states of the fluid and a pouring angular velocity of the source container, h_{container} is the distance from a pouring point m of the source container to a surface of the opening of the target container; and, calculating and generating the connectable domain of the source container by using a formula:
$${Ω}_{c o n t a i n e r} = {l}_{s} \times {( {l}_{l} / 2 + {h}_{c o n t a i n e r} )}^{2} tan α .$$

6. The optimized method according to claim 1, wherein the searching, by using the method of connectivity maximization, the pouring point of the source container which makes the intersection of the connectable domain of the source container and the target container maximum in the searching plane, and the pouring direction, comprising:
obtaining a projected plane by projecting the connectable region of the source container onto the searching plane;
dividing the projection plane of the connectable domain of the source container into a plurality of rectangles equally, and calculating and obtaining weight values of the plurality of the rectangles according to parameters of the connectable domain; and
searching, in the searching plane, for a sum of weights of the projection plane of the connectable domain of the source container contained in an edge trajectory of an opening of the target container, and making the pouring point m corresponding to [symbol] corresponding to a maximum value of the weight is the pouring point and the pouring direction of the source container; wherein, a projection of the pouring point m on the surface of the opening of the target container is set as m′, and [symbol] is a unit vector formed by extending an opening direction of the opening of the target container from a starting point m′ which is a projection of the pouring point m on the surface of the opening of the target container.

7. The optimized method according to claim 6, wherein the further obtaining positions of the pouring point on the source container, and then obtaining the pouring region according to a combination of the positions of the pouring point, comprising:
simplifying the search process according to existing pouring knowledge, wherein taking the centroid of the opening of the target container as a starting point, making rays outward at an interval angle to intersect with the edge trajectory of the opening of the target container, and taking the intersections as new starting points, performing a searching by making a direction of the [symbol] along the rays to the centroid, and finally the region composed of pouring points m of maximum sums of the weights contained in the edge trajectory of the opening of the target container is the pouring region being identified and optimized.

8. An optimized system for identifying robot pouring regions based on hierarchical processing and connectivity maximization, comprising:
a rough-identification module, being configured to perform a preliminary location of a target container based on environmental information image to obtain a spatial region of the target container; and being configured to generate a trajectory plan and a path plan of a mobile chassis of a mobile robot according to the spatial region of the target container; and
a fine-identification module, being configured to perform a fine identification by controlling a mechanical arm of the mobile robot to move to an information collection position according to the trajectory plan and the path plan, to obtain a pouring region;
wherein, a process of the fine identification specifically comprises:
acquiring image information of the target container and a source container;
generating corresponding connectable domain based on the image information of the target container and the source container; and
searching, by using a method of connectivity maximization, a pouring point of the source container which makes an intersection of the connectable domains of the source container and the target container maximum in a searching plane, and a pouring direction, further obtaining positions of the pouring point on the source container, and then obtaining the pouring region according to a combination of the positions of the pouring point.

9. A non-transitory computer-readable storage medium, having a computer program stored thereon, when the computer program is executed by a processor, implementing steps of the optimized method for identifying robot pouring regions based on hierarchical processing and connectivity maximization according to claim 1.

10. Computer equipment, comprising a memory, a processor, and a computer program stored on the memory and executable on the processor, when the processor executing the program, implementing steps of the optimized method for identifying robot pouring regions based on hierarchical processing and connectivity maximization according to claim 1.
